(19) United States
(12) Patent Application Publication
(10) Pub. No.: US 2024/0186618 A1
(43) Pub. Date: Jun. 6, 2024

(54) SEMI-SUBMERGED MODULE COOLING

(71) Applicant: RIMAC TECHNOLOGY LLC, Sveta Nedelja (HR)

(72) Inventor: Karlo Kramar, Vratišinec (HR)

(21) Appl. No.: 18/522,183

(22) Filed: Nov. 28, 2023

(30) Foreign Application Priority Data
Dec. 6, 2022 (EP) 22211613.9

(51) Int. Cl. H01M 10/6567; H01M 10/613; H01M 10/625; H01M 50/204; H01M 50/249

(52) U.S. Cl. CPC H01M 10/6567; H01M 10/613; H01M 10/625; H01M 50/204; H01M 50/249

(57) ABSTRACT

A battery module comprising: a plurality of battery cells, each having an elongated housing and having a pole at one end of the elongated housing; a module housing arranged to accommodate the plurality of battery cells; and a cell holder arranged to hold the individual ones of the plurality of battery cells and at least forming part of a division of an interior of the module housing into a first fluid chamber and a second fluid chamber; wherein the cell holder forms around each battery cell a first tight fit around the elongated housing at a first position recessed from the one end of the elongated housing and a second tight fit around the elongated housing at a second position recessed from an opposing end of the elongated housing to form a space between the first and second tight fits.

### CROSS-REFERENCE TO RELATED APPLICATION

This application claims priority to European Patent Application No. 22211613.9, filed on Dec. 6, 2022, the entire disclosure of which is incorporated herein by reference.

### TECHNICAL FIELD

The present application generally relates to a battery module and more particularly, to a battery module with semi-submerged module cooling.

### BACKGROUND

In a battery module, such as a battery module to be used in a variety of electric vehicles, a plurality of battery cells may be placed in the battery module to provide necessary power and voltage. In such a battery module, it is important that the battery module has a cooling system to not overheat the battery module and also to preserve high charging or discharging rate. For example, a thermal runaway which is one of the primary risks in lithium-ion batteries may occur if a battery module is not cooled down. It is a phenomenon in which a battery cell enters an unstoppable and uncontrollable chain reaction, and which causes a sudden release of energy stored in the battery cell. Also, batteries such as lithium-ion batteries have a preferred temperature region for exhibiting good performance. Thus, to prevent overheating of the battery and to ensure good performance of the battery, it is important that the battery module is equipped with the cooling system. For example, a coolant may be used to cool down the battery module.

However, the battery module filled with the coolant may increase a weight of the battery module and thereby increase a total weight of an electric vehicle using the battery module. This can be a problem, especially for vehicles in which high performance is needed. Furthermore, considering that a heat produced by a battery module may be hotter on a certain side of the plurality of battery cells where there are poles of the plurality of battery cells and interconnections, the cooling system can be further optimized. Moreover, the most of cooling systems using a coolant has risks such as leaking, corrosion and clogging due to their nature of using the coolant. Therefore, there is a further need to optimize the cooling system to use the coolant only where it is necessary.

### SUMMARY

The above problems are solved by the subject-matter of independent claims. Preferred embodiments are given by the subject-matter of dependent claims. Further examples are provided for facilitating the understanding of the invention.

According to an embodiment of the present invention, there is provided a battery module comprising: a plurality of battery cells, each having an elongated housing and having a pole at one end of the elongated housing; a module housing arranged to accommodate said plurality of battery cells; and a cell holder arranged to hold the individual ones of the plurality of battery cells and at least forming part of a division of an interior of the module housing into a first fluid chamber and a second fluid chamber; wherein the cell holder forms around each battery cell a first tight fit around the elongated housing at a first position recessed from the one end of the elongated housing and a second tight fit around the elongated housing at a second position recessed from an opposing end of the elongated housing to form a space between said first and second tight fits.

The present invention can provide a battery module which requires less coolant compared to conventional technologies. Also, the present invention can achieve a weight reduction in a battery module.

### BRIEF DESCRIPTION OF THE DRAWINGS

Embodiments of the present invention, which are presented for better understanding the inventive concepts, but which are not to be seen as limiting the invention, will now be described with reference to the figures in which:

FIG. 1 shows schematically a battery module according to an embodiment of the present invention;

FIG. 2 shows schematically a battery module with a fluid inlet port and a fluid outlet port according to an embodiment of the present invention;

FIG. 3 shows schematically a battery module with a filling material according to an embodiment of the present invention;

FIG. 4 shows schematically a battery module with cylindrical battery cells according to an embodiment of the present invention;

FIG. 5 shows schematically a battery module with a first lid, a second lid and an outer wall according to an embodiment of the present invention;

FIG. 6 shows schematically a battery module with a plurality of holes located on the outer wall according to an embodiment of the present invention;

FIG. 7 shows schematically a battery module with a third lid and the fourth lid according to an embodiment of the present invention;

FIG. 8 shows schematically a battery module with a rib according to an embodiment of the present invention; and

FIG. 9 shows schematically a battery module with a rib according to an embodiment of the present invention.

### DETAILED DESCRIPTION

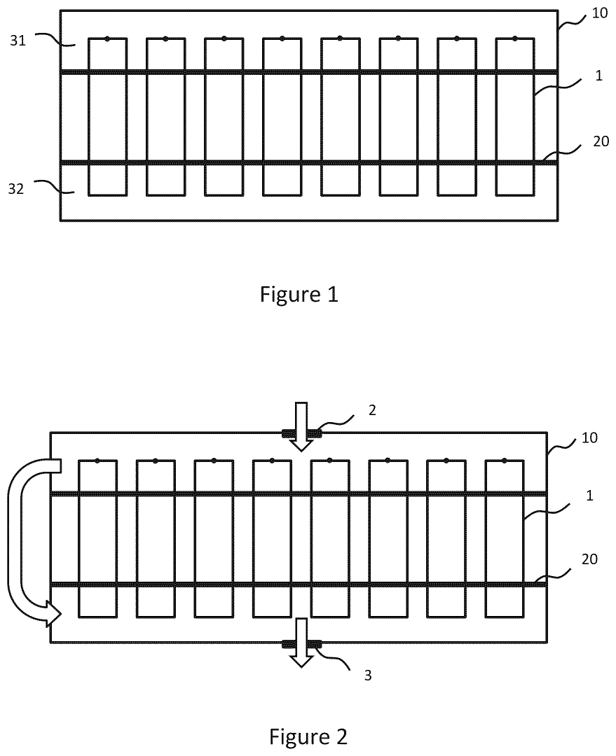

FIG. 1 shows schematically a battery module according to an embodiment of the present invention. The battery module comprises a plurality of battery cells 1, each having an elongated housing and having a pole at one end of the elongated housing; a module housing 10 arranged to accommodate said plurality of battery cells 1; and a cell holder 20 arranged to hold the individual ones of the plurality of battery cells 1 and at least forming part of a division of an interior of the module housing 10 into a first fluid chamber 31 and a second fluid chamber 32; wherein the cell holder 20 forms around each battery cell a first tight fit around the elongated housing at a first position recessed from the one end of the elongated housing and a second tight fit around the elongated housing at a second position recessed from an opposing end of the elongated housing to form a space between said first and second tight fits.

In the context of the present disclosure, the term “tight” is to be understood as impermeable in a way that a coolant, either in liquid or gas form, does not flow or go through. That is, the first tight fit and the second tight fit are impermeable.

Furthermore, the first position recessed from the one end of the elongated housing means that the first position is offset from the one end of the elongated housing. Similarly, the second position recessed from the opposing end of the elongated housing means that the second position is offset from the opposing end of the elongated housing.

Also, the first position and the second position may be relative to an axial direction of the elongated housing. Since the first position and the second position are relative to the axial direction of the elongated housing, the elongated housing can be divided into three parts on the axial direction of the elongated housing; from the one end of the elongated housing to the first position, from the first position to the second position, and from the second position to the opposing end of the elongated housing.

Moreover, the first tight fit at the first position and the second tight fit at the second position may and may not have a same distance each from the one end of the elongated housing and the opposing end of the elongated housing. Preferably, the first position and the second position may be apart from each end of the elongated housing with a same distance. However, the battery module of the present embodiment is not limited thereto.

In the battery module of the present embodiment, the first position and the second position may not be fixed and can range from 0 mm to 40% of battery cell height. The expression “0 mm” may be understood as where only ends of each of the plurality of battery cells 1 may be exposed to a coolant, that is, touching of the coolant may not be excluded. By adjusting the first position and the second position closer to each end of the plurality of battery cells, the battery module may achieve a weight reduction, if the battery module is provided with the coolant. By exposing the plurality of battery cells 1 more to a coolant, if the battery module is provided with the coolant, a higher cooling efficiency may be achieved. Thus, for maximum cooling efficiency, the first position and the second position may be offset by 40% of battery cell height from each end of each of the plurality of battery cells 1. That is, the first position and the second position can be adjusted according to use cases.

The battery module of the embodiment may have a variety of module orientations. In other words, an orientation of the battery module is not limited to a specific direction and the battery module can be used in any orientation.

By having the space between the first tight fit and the second tight fit, it is possible to require, for the battery module of the present embodiment, less coolant usage in battery module cooling.

Furthermore, in the battery module according to present embodiment, it is possible to increase safety with regard to thermal runaway events. Since each pole of each of the plurality of battery cells 1, where it can be hotter than the other part of each of the plurality of batteries, is located in a space where a coolant can flow in the battery module, if the battery module is provided with the coolant, safety of the battery module may be increased, and the thermal runaway events may be avoided.

In an embodiment of the present invention, which can be combined with any of other embodiments of the present invention, the battery module may further comprise a coolant. Therefore, the battery module can be provided with the coolant. The coolant may be, for example, a liquid coolant such as dielectric oil or even a gas or solid coolant. That is, the coolant may be not limited to any specific type.

The battery module may further comprise a fluid inlet port 2 for allowing a coolant flow into the first fluid chamber 31; and a fluid outlet port 3 for allowing a coolant flow from the second fluid chamber 32; wherein the first fluid chamber 31 and the second fluid chamber 32 are connected in a way that a coolant can pass from the first fluid chamber 31 to the second fluid chamber 32.

FIG. 2 shows schematically the battery module according to an embodiment of the present invention. Although it is shown in FIG. 2 as the first fluid chamber 31 and the second fluid chamber 32 are connected by a path that is located outside of the battery module, this illustration is merely for an understanding of the invention and the embodiment of the present invention is not limited thereto. Furthermore, arrows depicted in FIG. 2 are merely to understand a coolant flow if the battery module is provided with a coolant. That is, the arrows depicted in FIG. 2, as well as in other drawings of the present disclosure, may not imply a structural element.

In the battery module of the present embodiment, positions of the fluid inlet port 2 and the fluid outlet port 3 may be each located on any part of the first fluid chamber and the second fluid chamber depending on use cases. Furthermore, shapes and dimensions of the fluid inlet port 2 and the fluid outlet port 3 may be same or different.

In the first fluid chamber 31, especially where poles of the plurality of battery cells 1 are located, bigger temperature difference may be expected and a temperature difference may be smaller at the opposing end of each of the plurality of battery cells 1. That is, a part closer to poles of the plurality of battery cells 1 may have more heat generation. Thus, it is important that the battery module enables a coolant to touch this part, specifically, the poles of the plurality of battery cells 1 and the interconnections, if the battery module is used with the coolant.

Thus, by allowing the coolant flow first into the first fluid chamber 31, where the poles of the plurality of battery cells 1 are located, it may be possible to optimize the battery module to achieve an efficient cooling system.

Moreover, the battery module according to the present embodiment may enable the plurality of battery cells 1 to have a temperature difference smaller than 5° C. within each of the plurality of battery cells 1 by connecting the first fluid chamber 31 and the second fluid chamber 32 in a way that a coolant can pass from the first fluid chamber 31 to the second fluid chamber 32.

The battery module may drive the coolant flow on the short side of the battery module to minimize pressure drop and temperature arise in the coolant flow. That is, the fluid inlet port 2 and the fluid outlet port 3 may be located on a side of the battery module so that the location of the fluid inlet port 2 and the fluid outlet port 3 shorten a path of the coolant flow allowed into the first fluid chamber 31, passed from the first fluid chamber 31 to the second fluid chamber 32 and allowed to leave from the second fluid chamber 32 and thereby preventing the pressure drop in the coolant flow and minimizing the temperature arise caused by cooling the plurality of the battery cells 1.

Furthermore, it may be possible to provide a single flow on both ends of the plurality of battery cells 1 to minimize system complexity. The single flow may mean that the coolant flow is in one direction or substantially in one direction which can be understood as, if the battery module is provided with a coolant, the coolant entering through the fluid inlet port 2 would exit the first fluid chamber 31 only through one side of the first fluid chamber 31 and the coolant entering the second fluid chamber 32 through one side of the second fluid chamber 32 would exit the second fluid chamber 32 only through the fluid outlet port 3.

Moreover, it may be possible to further optimize performance of the battery module by having variability between the fluid inlet port 2 and the fluid outlet port 3, that is, by having different shapes and dimensions of the fluid inlet port 2 and the fluid outlet port 3. Also, both shape and thickness of coolant flow layer of the battery module may be further optimized depending on use cases by adjusting the shapes and dimensions of the fluid inlet port 2 and the fluid outlet port 3, and locations of the first tight fit and the second tight fit.

According to an embodiment of the present invention, the space between the first tight fit and the second tight fit may be void. In this case, the battery module according to the present embodiment may reduce a total weight of the battery module. Since the space may be void, that is, not to be filled with a coolant, if the battery module is used with the coolant, the battery module may achieve a weight reduction compared to a conventional battery module without such a void space.

According to another embodiment of the present invention, a filling material 4 may be arranged in the space between the first tight fit and the second tight fit. The filling material 4 may have lesser density than a coolant, if the battery module is used with the coolant. That is, for the battery module further comprising a coolant, the filling material 4 may have lesser density than the coolant. The expression of “if the battery module is provided with a coolant”, “if the battery module is used with a coolant” or any other equivalent expression, it may be understood that the battery module further comprises the coolant. In this case, the battery module according to the present embodiment may reduce a total weight of the battery module. Since the space may be filled with the filling material 4 having lesser density than the coolant, if the battery module is used with the coolant, the battery module may achieve a weight reduction compared to a conventional battery module without such a filled space.

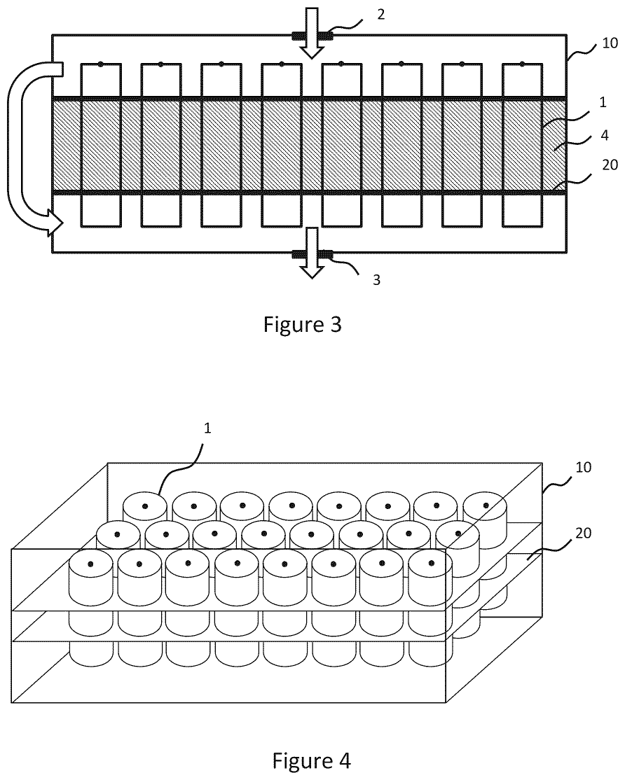

As it can be seen in FIG. 3, the space may be filled with the filling material 4. Thus, the battery module may be a semi-submerged battery module, that is, the plurality of battery cells 1 may be not fully submerged in a coolant, if the battery module is provided with the coolant.

The density of the filling material 4, however, may be not limited to be lesser than a density of the coolant. Independent of the density of the filling material 4, the battery module may be able to reduce a necessary amount of the coolant as there is the space in the battery.

The filling material 4 may be a porous material composed of a solid part and a void part. For example, the filling material 4 may be a foam such as polyurethane, polystyrene or expanded polystyrene. However, the filling material 4 may be not limited to these examples and may even be a 3D printed lattice.

Also, the density of the filling material 4 may be less than 800 kg/m3. Since a density of dielectric oil, which can be used as a coolant for the battery module, or other coolants may be greater than the density of the filling material 4. Thus, a weight reduction in the battery module may be achieved.

According to the embodiment of the present invention, where there may be the filling material 4 arranged in the space of the cell holder 20, the cell holder 20 may be formed from thermoplastic. Also, the cell holder 20 may be overmolded around the filling material 4.

Thermoplastic is a material that is moldable at a certain elevated temperature and solidifies upon cooling. Therefore, the cell holder 20 being formed from thermoplastic may be adequate for overmolding.

In this way, the battery module according to the present embodiment may not require any bonding between the filling material 4 and the cell holder 20. Furthermore, since the overmolded cell holder may not only bond the filling material 4 with the cell holder 20 but also seal the filling material 4, it may be possible to ensure that the first tight fit and the second tight fit are impermeable.

As shown in FIG. 4, the elongated housing of each of the plurality of battery cells 1 of the battery module may be cylindrical. Furthermore, the plurality of battery cells 1 may be arranged vertically next to each other. The plurality of battery cells 1 may be arranged vertically in a two-dimensional array but also in a zig-zig arrangement or another arrangement.

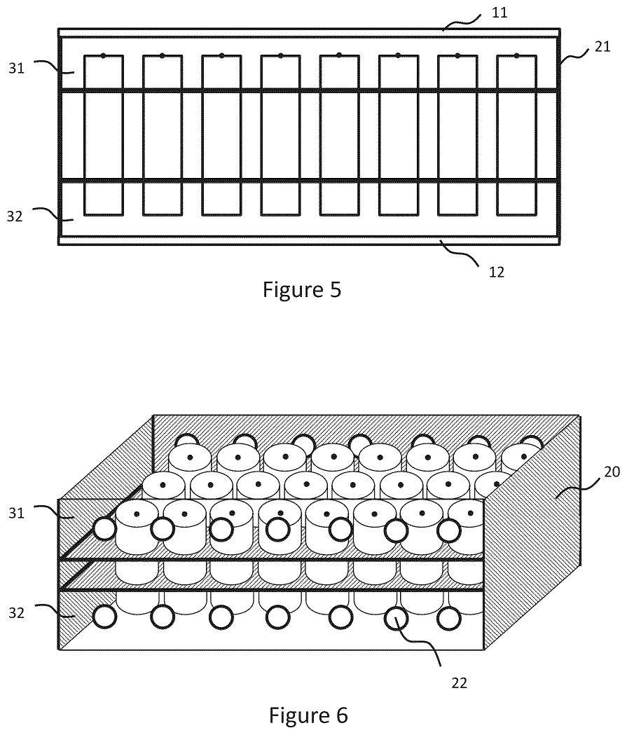

As shown in FIG. 5, the module housing 10 may comprise a first lid 11 arranged at least over the one end of the elongated housing of each of the plurality of battery cells 1 and a second lid 12 arranged at least over the opposing end of the elongated housing of each of the plurality of battery cells 1; and the cell holder 20 further forms an outer wall 21 between the first lid 11 and the second lid 12.

In the battery module, the first fluid chamber 31 may be formed between the first tight fit and the first lid 11, and also by the outer wall 21. Also, the second fluid chamber 32 may be formed between the second tight fit and the second lid 12, and also by the outer wall 21. That is, the first fluid chamber 31 may be defined by the first tight fit, the first lid 11 and the outer wall 21, and the second fluid chamber 32 may be defined by the second tight fit, the second lid 12 and the outer wall 21.

The first lid 11 and the second lid 12 may be configured to seal each the first fluid chamber 31 and the second fluid chamber 32. Thus, if the battery module is provided with a coolant, the coolant in the first fluid chamber 31 and the second fluid chamber 32 may be prevented from going out.

As shown in FIG. 6, the battery module may further comprise a plurality of holes 22 located on the outer wall 21 and accessible to the first fluid chamber 31 and the second fluid chamber 32. Note that, although the cell holder 20 has been illustrated without one side of the outer wall 21, this is merely for an illustrative purpose and the hatched part in FIG. 6 does not limit the cell holder 20 or the outer wall 21.

The plurality of holes may be in different shapes and dimensions. That is, the plurality of holes can be further optimized depending on use cases by adjusting both shapes and dimensions of the plurality of holes. Furthermore, each of the plurality of holes may have same shape and dimension but also different shapes and dimensions to each other.

The battery module may further comprise: a third lid 13 and a fourth lid 14 may be located on opposite sides to each other and in parallel with an axial direction of the plurality of battery cells 1, wherein the fluid inlet port 2 and the fluid outlet port 3 may be located on the fourth lid 14, and the first fluid chamber 31 and the second fluid chamber 32 may be connected through a space between the third lid 13 and a part of the outer wall 21 facing the third lid 13. Specifically, the first fluid chamber 31 and the second fluid chamber 32 may be connected through the space between the third lid 13 and the part of the outer wall 21 facing the third lid 13 in a way that a coolant can pass from the first fluid chamber 31 to the second fluid chamber 32.

The third lid 13 and the fourth lid 14 may be configured to seal each the space between the third lid 13 and the part of the outer wall 21 facing the third lid 13, and a space between the fourth lid 14 and a part of the outer wall 21 facing the fourth lid 14. Thus, the third lid 13 and the fourth lid 14 may be configured to have a form which is appropriate to seal corresponding space. Therefore, if the battery module is provided with a coolant, the coolant in these spaces may be prevented from going out.

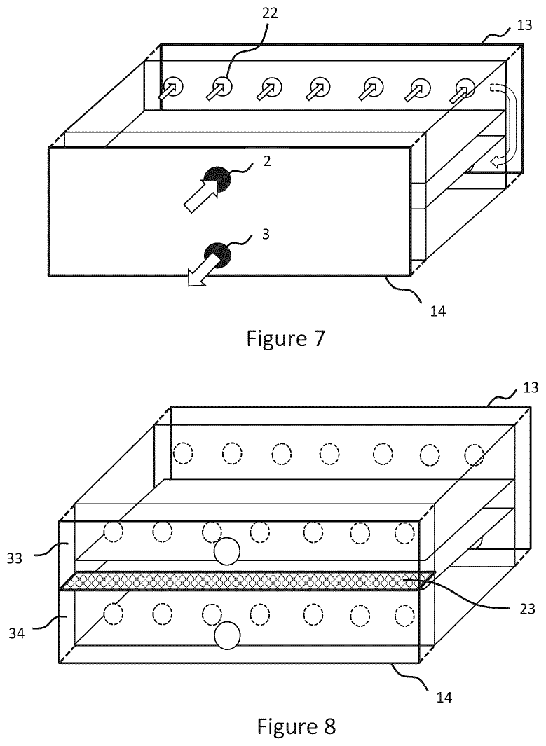

As shown in FIG. 7, in case a coolant is provided in the battery module, the coolant may enter through the fluid inlet port 2 into the space between the fourth lid 14 and the part of the outer wall 21 facing the fourth lid 14, then enter through the plurality of holes located on the outer wall into the first fluid chamber 31, flow into the first fluid chamber 31 while touching the poles and a submerged part of the plurality of battery cells 1 and the interconnections, enter through the plurality of holes located on the outer wall 21 into a space between the third lid 13 and the part of the outer wall 21 facing the third lid 13, and then go around making a U-turn.

After the U-turn, that is, after a direction of the coolant flow is changed in the space between the third lid 13 and the part of the outer wall 21 facing the third lid 13, the coolant may enter through the plurality of holes located on the outer wall 21 into the second fluid chamber 32, flow into the second fluid chamber 32 while touching at least a submerged part of the plurality of battery cells 1, then enter through the plurality of holes located on the outer wall 21 into the space between the fourth lid 14 and the part of the outer wall 21 facing the fourth lid 14, and then leave the battery module through the fluid outlet port 3 located on the fourth lid 14.

Although FIG. 7 is illustrated with the plurality of holes, this is merely for an illustrative purpose and the third lid 13 and the fourth lid 14 may not be limited to be used with the plurality of holes. For example, the third lid 13 and the fourth lid 14 may be configured to the battery module illustrated in FIG. 2 where the fluid inlet port 2 and the fluid outlet port 3 are defined.

Furthermore, the space between the fourth lid 14 and the part of the outer wall 21 facing the fourth lid 14 where the coolant can enter through the fluid inlet port 2 and where the coolant can leave through the fluid outlet port 3 may be separated in a way that the coolant that has entered through the fluid inlet port 2 and the coolant that has left through the fluid outlet port 3 would not be mixed.

This separation of the space between the fourth lid 14 and the part of the outer wall 21 facing the fourth lid 14 may be achieved by a rib. As shown in FIG. 8, the cell holder 20 of the battery module may further comprise: a rib 23 configured to at least form part of a division of a space between the fourth lid 14 and a part of the outer wall 21 facing the fourth lid 14 into a fluid inlet chamber 33 and a fluid outlet chamber 34.

Further to separating of the space between the fourth lid 14 and the part of the outer wall 21 facing the fourth lid 14 into the fluid inlet chamber 33 and the fluid outlet chamber 34, the rib 23 may be configured to seal a space between the fluid inlet chamber 33 and the fluid outlet chamber 34.

For example, the rib 23 may define a space between the fluid inlet chamber 33 and the fluid outlet chamber 34. The space between the fluid inlet chamber 33 and the fluid outlet chamber 34 may be sealed so that a coolant, if the coolant is provided in the battery module, would not be filled in the space between the fluid inlet chamber 33 and the fluid outlet chamber 34. Therefore, the rib 23 may be configured to seal a space between the fluid inlet chamber 33 and the fluid outlet chamber 34.

The sealing of the space by the rib 23 may be achieved in different ways. For example, the fourth lid 14 may have a groove where the rib 23 can be placed, and the rib 23 may be glued to the groove so that the space between the fluid inlet chamber 33 and the fluid outlet chamber 34 can be sealed. Also, a part of rib 23 may be welded by a laser welding, that is a material of the rib 23 may be melted and connected to the fourth lid 14 to seal the space between the fluid inlet chamber 33 and the fluid outlet chamber 34.

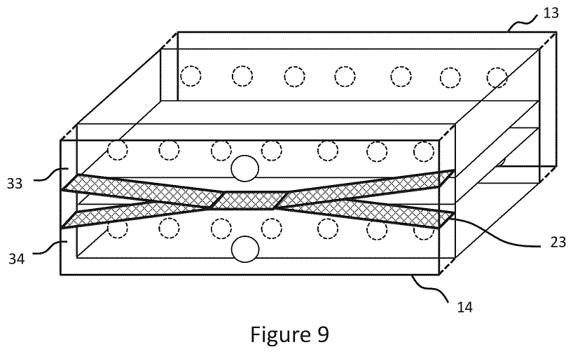

As shown in FIG. 9, a distance between the fluid inlet chamber 33 and the fluid outlet chamber 34 may be greater on distal parts of the fluid inlet chamber 33 and the fluid outlet chamber 34. That is, the space between the fluid inlet chamber 33 and the fluid outlet chamber 34 may have different distances between the fluid inlet chamber 33 and the fluid outlet chamber 34, for example, in distal and central parts of the space. The distal part may be understood as a peripheral part or a part that is closer to an edge than a center.

By having a greater distance between the fluid inlet chamber 33 and the fluid outlet chamber 34 on distal parts, the rib 23 may achieve uniform cooling by enabling a faster distribution of a coolant, if the coolant is provided in the battery module, allowed into the fluid inlet port 2 to the plurality of holes located on the outer wall 21.

However, configuration of the rib 23 may be not limited to any form or orientation and may be adjusted to use cases.

Furthermore, the rib 23 may be configured to support a part of the outer wall 21. Since the rib 23 may be located next to the outer wall 21, the rib 23 may support the outer wall 21 to prevent bulging of the battery module. That is, the rib 23 may support the outer wall 21 to increase structural stability of the battery module.

The cell holder 20 of the present invention may further comprise a first sealant and a second sealant, each further making the first tight fit and the second tight fit.

The first sealant and the second sealant may be formed from epoxy, but their material is not limited to any type. For example, the material for the first sealant and the second sealant may be an insulating liquid compound that may be used in potting. Moreover, the materials for the first sealant and the second sealant may be same or different.

The cell holder 20 of the present invention may be used independently in some other applications. The cell holder 20 of the present invention may be not limited to a specific battery module.

According to an embodiment of the present invention, the cell holder 20 may be manufactured by a method of manufacturing the cell holder. The method may comprise: providing a filling material; overmolding a cell holder around the filling material; and providing a plurality of holes in the cell holder.

The filling material may be provided for overmolding the cell holder around the filling material.

The cell holder may be overmolded around the filling material until two parts, the cell holder and the filling material, are solidified. That is, the cell holder and the filling material may be bonded without any additional adhesives.

The plurality of holes may be provided for the plurality of battery cells 1. Thus, the plurality of holes may be provided with appropriate dimensions for the plurality of battery cells 1.

Furthermore, providing the plurality of holes may mean machining the plurality of holes in the cell holder. For example, the plurality of holes may be drilled into the cell holder. In this case, it can be understood that the filling material around which is overmolded with the cell holder is machined together with the cell holder.

Providing the plurality of holes may be understood as providing each of the plurality of holes vertically next to each other. In other words, providing the plurality of holes can be understood as providing each of the plurality of holes parallel and adjacent to each other.

A battery module according to another embodiment of the present invention may be manufactured by a method of manufacturing the battery module. The method may comprise: providing a plurality of battery cells 1, each having an elongated housing and having a pole at one end of the elongated housing; providing a module housing 10 to accommodate the plurality of battery cells 1; providing a cell holder 20 arranged to hold the individual ones of the plurality of battery cells 1 and at least forming part of a division of an interior of the module housing 10 into a first fluid chamber 31 and a second fluid chamber 32, wherein the cell holder 20 forms around each battery cell a first tight fit around the elongated housing at a first position recessed from the one end of the elongated housing and a second tight fit around the elongated housing at a second position recessed from an opposing end of the elongated housing to form a space between said first and second tight fits.

The cell holder 20 may be provided by the method of manufacturing the cell holder introduced in the previous embodiment. However, providing of the cell holder 20 may be not limited thereto and may be manufactured in another way. For example, if the space should be void, that is, if the method does not comprise providing a filling material 4, the cell holder may be not overmolded around the filling material but rather be formed to form the space between the first tight fit and the second tight fit.

The method may further comprise: providing a filling material 4. The filling material having lesser density than a coolant may be provided in the space.

The method may further comprise: filling a coolant in the first fluid chamber 31 and the second fluid chamber 32.

The method may further comprise: before providing the plurality of battery cells 1, applying a sealant on a top and a bottom surface of the filling material to each make a first tight fit and a second tight fit perpendicular to a lateral surface of the filling material.

The method may further comprise: providing a fluid inlet port 2 for allowing a coolant flow into the first fluid chamber 31; and a fluid outlet port 3 for allowing a coolant flow from the second fluid chamber 32; wherein the first fluid chamber 31 and the second fluid chamber 32 are connected in a way that a coolant can pass from the first fluid chamber 31 to the second fluid chamber 32.

1. A battery module comprising:
a plurality of battery cells, each of the plurality of battery cells having an elongated housing and having a pole at one end of the elongated housing;
a module housing arranged to accommodate the plurality of battery cells; and
a cell holder arranged to hold an individual battery cell of the plurality of battery cells and at least forming part of a division of an interior of the module housing into a first fluid chamber and a second fluid chamber;
wherein the cell holder forms around each battery cell a first tight fit around the elongated housing at a first position recessed from the one end of the elongated housing and a second tight fit around the elongated housing at a second position recessed from an opposing end of the elongated housing to form a space between the first tight fit and the second tight fit;
wherein the battery module further comprises:
a fluid inlet port for allowing a coolant flow into the first fluid chamber; and
a fluid outlet port for allowing a coolant flow from the second fluid chamber;
wherein the first fluid chamber and the second fluid chamber are connected in a way that a coolant can pass from the first fluid chamber to the second fluid chamber.

2. The battery module according to claim 1, wherein the space is void.

3. The battery module according to claim 1, wherein a filling material is arranged in the space.

4. The battery module according to claim 3, wherein:
the filling material is a porous material composed of a solid part and a void part;
a density of the filling material is less than 800 kg/m3.

5. The battery module according to claim 3, wherein the cell holder is formed from thermoplastic and overmolded around the filling material.

6. The battery module according to claim 1, wherein the elongated housing is cylindrical.

7. The battery module according to claim 1, wherein:
the module housing comprises a first lid arranged at least over the one end of the elongated housing of each of the plurality of battery cells and a second lid arranged at least over the opposing end of the elongated housing of each of the plurality of battery cells; and
the cell holder further forms an outer wall between the first lid and the second lid.

8. The battery module according to claim 7, wherein the cell holder further comprises:
a plurality of holes located on the outer wall and accessible to the first fluid chamber and the second fluid chamber.

9. The battery module according to claim 7, wherein the module housing further comprises:
a third lid and a fourth lid are located on opposite sides to each other and in parallel with an axial direction of the plurality of battery cells;
wherein the fluid inlet port and the fluid outlet port are located on the fourth lid, and
wherein the first fluid chamber and the second fluid chamber are connected through a space between the third lid and a part of the outer wall facing the third lid.

10. The battery module according to claim 9, wherein the cell holder further comprises:
a rib configured to at least form part of a division of a space between the fourth lid and a part of the outer wall facing the fourth lid into a fluid inlet chamber and a fluid outlet chamber.

11. The battery module according to claim 10, wherein the rib is configured to seal a space between the fluid inlet chamber and the fluid outlet chamber.

12. The battery module according to claim 10, wherein a distance between the fluid inlet chamber and the fluid outlet chamber is greater on distal parts of the fluid inlet chamber and the fluid outlet chamber.

13. The battery module according to claim 10, wherein the rib is configured to support a part of the outer wall.

14. The battery module according to claim 1, wherein the cell holder further comprises:
a first sealant and a second sealant, each further making the first tight fit and the second tight fit.

15. A vehicle, comprising:
a battery module, comprising:
a plurality of battery cells, each of the plurality of battery cells having an elongated housing and having a pole at one end of the elongated housing;
a module housing arranged to accommodate the plurality of battery cells; and
a cell holder arranged to hold individual battery cells of the plurality of battery cells and at least forming part of a division of an interior of the module housing into a first fluid chamber and a second fluid chamber;
wherein the cell holder forms around each battery cell a first tight fit around the elongated housing at a first position recessed from the one end of the elongated housing and a second tight fit around the elongated housing at a second position recessed from an opposing end of the elongated housing to form a space between the first tight fit and the second tight fit;
wherein the battery module further comprises:
a fluid inlet port for allowing a coolant flow into the first fluid chamber; and
a fluid outlet port for allowing a coolant flow from the second fluid chamber;
wherein the first fluid chamber and the second fluid chamber are connected in a way that a coolant can pass from the first fluid chamber to the second fluid chamber.
